(19) United States
(12) Patent Application Publication
(10) Pub. No.: US 2007/0188433 A1
(43) Pub. Date: Aug. 16, 2007

(54) Display device

(75) Inventors: Kozo Yasuda, Mobara (JP); Katsumi Matsumoto, Mobara (JP); Toshio Miyazawa, Chiba (JP)

Correspondence Address: Stanley P. Fisher;Reed Smith LLP, Suite 1400, 3110 Fairview Park Drive, Falls Church, VA, 22042, US

(73) Assignee: HITACHI DISPLAYS, LTD.

(21) Appl. No.: 11/647,255

(22) Filed: Dec. 29, 2006

(30) Foreign Application Priority Data
Feb. 14, 2006 (JP) 2006-036348

(51) Int. Cl. G09G 3/36

(52) U.S. Cl. 345/92

(57) ABSTRACT

A display device which stores display data for every display pixel can reduce the number of transistors which constitute 1 display pixel. In a display device which includes a display panel having a plurality of display pixels, video lines which apply video data to the display pixels and scanning lines which apply a scanning voltage to the display pixels, the display pixel includes: a capacitive element which holds a voltage corresponding to a value of the video data; a pixel electrode; a first transistor of a first conductive type which is connected between a first power source line and the pixel electrode and, at the same time, has a control electrode to which the voltage held in the capacitive element is applied; and a second transistor of a second conductive type different from the first conductive type which is connected between a second power source line and the pixel electrode and, at the same time, has a control electrode to which the voltage held in the capacitive element is applied. Here, a first voltage is supplied to the first power source line, and a second voltage is supplied to the second power source line. The second voltage is a voltage which is obtained by inverting the first voltage.

### BACKGROUND OF THE INVENTION

The present invention relates to a display device such as a liquid crystal display device or an EL display device, and more particularly to a display device which stores display data for respective display pixels.

Inventors of the present invention have proposed a low-power-consuming and highly-functional liquid crystal display device which arranges a memory in each display pixel in the inside of a liquid crystal display panel, stores display data in the memory thus allowing the liquid crystal display panel to display an image even when there is no input signal from the outside (see patent document 1 described below).

FIG. 8 is an equivalent circuit diagram showing the constitution of 1 display pixel described in the above-mentioned patent document 1.

In the drawing, an n-type transistor (TR3) is turned on when a voltage of a node (node1) assumes an H level and applies a voltage of VCOM to a pixel electrode (ITO1). An n-type transistor (TR4) is turned on when a node (node2) assumes an H level and applies a voltage of VCOMB which is obtained by inverting the voltage of VCOM to the pixel electrode (ITO1).

When a selective scanning voltage (for example, H level) is applied to a scanning line (G), an n-type transistor (TR1) is turned on and a p-type transistor (TR2) is turned off and hence, data (“1” or “0”) to be applied to a video line (D) is written in the node (node1). That is, the writing operation is performed.

Further, when a non-selective scanning voltage (for example, an L level) is applied to the scanning line (G), the n-type transistor (TR1) is turned off and the p-type transistor (TR2) is turned on and hence, a data value which is written in the node (node1) is held in a memory part which is formed of inverter circuits (INV1, INV2). That is, the holding operation is performed. Accordingly, the image is displayed on the display part even during a period in which there is no image input.

For example, in the case of a normally-white-type liquid crystal display panel, when “1” is written in the node (node1) (when “0” is written in the node (node2)), the liquid crystal display panel assumes a white display mode, and when “0” is written in the node (node1) (when “1” is written in the node (node2)), the liquid crystal display panel assumes a black display mode.

Here, as a prior art document relevant to the present invention, a following patent document is named.

[Patent document 1] U.S. application Ser. No. 11/378,309

### SUMMARY OF THE INVENTION

However, the constitution shown in FIG. 8 requires eight transistors as transistors for constituting 1 display pixel and hence, the number of transistor elements which constitute 1 display pixel is large thus giving rise to a drawback that the number of pixels of the liquid crystal display panel cannot be largely increased.

The present invention has been made to overcome the above-mentioned drawbacks of the related art, and it is an object of the present invention to provide a technique which can reduce the number of transistors which constitute 1 display pixel in a display device which stores display data for each display pixel.

The above-mentioned and other objects and novel features of the present invention will become apparent from the description of this specification and attached drawings.

To briefly explain the summary of typical inventions among the inventions disclosed in this specification, they are as follows.

(1) In a display device which includes a display panel having a plurality of display pixels, video lines which apply video data to the display pixels and scanning lines which apply a scanning voltage to the display pixels,

the display pixel includes a capacitive element which holds a voltage corresponding to a value of the video data, a pixel electrode, a first transistor of a first conductive type which is connected between a first power source line and the pixel electrode and, at the same time, has a control electrode to which the voltage corresponding to the value of the video data is applied, and a second transistor of a second conductive type different from the first conductive type which is connected between a second power source line and the pixel electrode and, at the same time, has a control electrode to which the voltage corresponding to the value of the video data is applied,

a first voltage is supplied to the first power source line, and

a second voltage is supplied to the second power source line, the second voltage being a voltage which is obtained by inverting the first voltage.

(2) In the above-mentioned constitution (1), the display pixel includes an active element which is turned off when a non-selective scanning voltage is applied to the scanning line and is turned on when a selective scanning voltage is applied, and a voltage corresponding to the value of the video data is applied to the capacitive element from the video line via the active element.

(3) In the above-mentioned constitution (1) or (2), when the video data assumes “1”, the first transistor is turned on and the second transistor is turned off, while when the video data assumes “0”, the first transistor is turned off and the second transistor is turned on.

(4) In any one of the above-mentioned constitutions (1) to (3), the display pixel includes a common electrode which faces the pixel electrode in an opposed manner, and the first voltage is applied to the common electrode.

(5) In any one of the above-mentioned constitutions (1) to (4), the first voltage has a voltage level thereof inverted from a High level to a Low level or from the Low level to the High level at a predetermined inversion cycle.

(6) In a display device which includes a display panel having a plurality of display pixels, video lines which apply video data to the display pixels and scanning lines which apply a scanning voltage to the display pixels,

the display pixel includes a pixel electrode, a first transistor of a first conductive type which is connected between a first power source line and the pixel electrode and, at the same time, has a control electrode to which the voltage corresponding to the value of the video data is applied, and a second transistor of a second conductive type different from the first conductive type which is connected between a second power source line and the pixel electrode and, at the same time, has a control electrode to which the voltage corresponding to the value of the video data is applied,

either one of a first voltage and a second voltage is supplied to the first power source line, and

another one of the first voltage and the second voltage is supplied to the second power source line, the second voltage being a voltage which is obtained by inverting the first voltage.

(7) In the above-mentioned constitution (6), the display pixel includes an active element which is turned off when a non-selective scanning voltage is applied to the scanning line and is turned on when a selective scanning voltage is applied, and a voltage corresponding to the value of the video data is applied to the control electrodes of the first transistor and the second transistor from the video line via the active element.

(8) In the above-mentioned constitution (6) or (7), when the video data assumes “1”, the first transistor is turned on and the second transistor is turned off, while when the video data assumes “0”, the first transistor is turned off and the second transistor is turned on.

(9) In any one of the above-mentioned constitutions (6) to (8), the first transistor, when the first transistor assumes an ON state and, thereafter, the voltage corresponding to the value of the video data is not applied to the control electrode, maintains the ON state due to a voltage held in a first parasitic capacitance between a first electrode and the control electrode of the first transistor, and the second transistor, when the second transistor assumes an ON state and, thereafter, the voltage corresponding to the value of the video data is not applied to the control electrode of the second transistor, maintains the ON state due to a voltage held in a second parasitic capacitance between a first electrode and the control electrode of the second transistor.

(10) In any one of the above-mentioned constitutions (6) to (9), the display pixel includes a common electrode which faces the pixel electrode in an opposed manner and the first voltage is applied to the common electrode.

(11) In any one of the above-mentioned constitutions (6) to (10), the first voltage has a voltage level thereof inverted from a High level to a Low level or from the Low level to the High level at a predetermined inversion cycle.

(12) In any one of the above-mentioned constitutions (6) to (11), when a voltage level of the first voltage assumes a Low level, the first voltage is supplied to the first power source line and the second voltage is supplied to the second power source line, while when a voltage level of the first voltage assumes a High level, the second voltage is supplied to the first power source line and the first voltage is supplied to the second power source line.

(13) In the constitution (12), the display device includes a selection circuit which selects the first voltage or the second voltage as the voltage supplied to the first power source line and the second power source line in response to the voltage level of the first voltage.

(14) In any one of the above-mentioned constitutions (6) to (13), the display device includes a data inversion circuit which inverts the video data in response to the voltage level of the first voltage.

(15) In the constitution (14), the data inversion circuit does not invert the video data when the voltage level of the first voltage assumes the Low level and inverts the video data when the voltage level of the first voltage assumes the High level.

(16) In any one of the above-mentioned constitutions (1) to (15), M pieces of display pixels constitute 1 sub pixel.

(17) In the constitution (16), M pieces of display pixels which constitute 1 sub pixel make areas of the respective pixel electrodes thereof different from each other.

(18) In the constitution (17), the video data is video data of m(m≧2) bits, M is m, and weighting is applied to the areas of the pixel electrodes of the respective M pieces of display pixels which constitute 1 sub pixel substantially at a rate of 2⁰:2¹: , . . . , :2^{(m-1)}.

(19) In the above-mentioned constitutions (1) to (18), the display device is a liquid crystal display device.

To briefly explain advantageous effects obtained by typical inventions among the inventions disclosed in this specification, they are as follows.

According to the present invention, in the display device which stores display data for each display pixel, the number of transistors which constitute 1 display pixel can be reduced.

### BRIEF DESCRIPTION OF THE DRAWINGS

FIG. 1 is a block diagram showing the schematic constitution of a display device of an embodiment 1 according to the present invention;

FIG. 2 is a view showing an equivalent circuit of a display pixel of the display device of the embodiment 1 according to the present invention;

FIG. 3 is a view showing the relationship between a voltage of VCOM and a voltage of a VCOMB which is obtained by inverting the voltage of VCOM of the display device of the embodiment 1 according to the present invention;

FIG. 4 is a block diagram showing the schematic constitution of a display device of an embodiment 2 according to the present invention;

FIG. 5 is a view showing an equivalent circuit of a display pixel of the display device of the embodiment 2 according to the present invention;

FIG. 6 is a view showing the circuit constitution of a VCOM selector circuit shown in FIG. 4;

FIG. 7A and FIG. 7B are views showing the constitution of a display pixel of a display device of the embodiment 3 according to the present invention; and

FIG. 8 is an equivalent circuit diagram showing the constitution of 1 display pixel of a display device which is already proposed by inventors of the present invention.

### DESCRIPTION OF THE PREFERRED EMBODIMENTS

Hereinafter, embodiments in which the present invention is applied to a liquid crystal display device are explained in detail in conjunction with drawings.

Here, in all drawings for explaining the embodiments, parts having identical functions are given same numerals and their repeated explanation is omitted.

### Embodiment 1

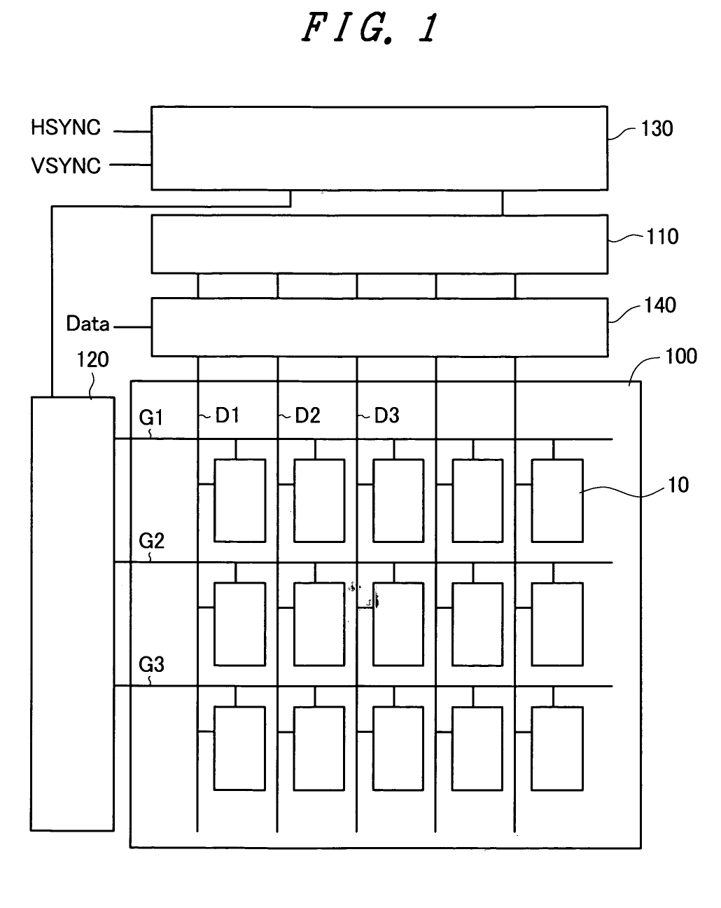

FIG. 1 is a block diagram showing the schematic constitution of a liquid crystal display device of an embodiment 1 according to the present invention.

In FIG. 1, numeral 100 indicates a display part, numeral 110 indicates a horizontal shift register circuit (also referred to as a video-line shift register circuit), numeral 120 indicates a vertical shift register circuit (also referred to as a scanning-line shift register circuit), numeral 130 indicates an interface circuit, numeral 140 indicates a data latch circuit, and numeral 10 indicates a display pixel.

The display part 100 includes a plurality of display pixels 10 which is arranged in a matrix array, video lines (also referred to as drain lines) D(D1, D2, D3 . . . ) which supply display data to the respective display pixels 10, and scanning lines (also referred to as gate lines) G(G1, G2, G3 . . . ) which supply scanning signals to the respective display pixels 10.

The interface circuit 130 generates a drive pulse for driving the horizontal shift register circuit 110 based on a horizontal synchronizing signal (HSYNC) and a vertical synchronizing signal (VSYNC) which are inputted and a drive pulse for driving the vertical shift register circuit 120.

The data latch circuit 140 stores inputted display data (Data) amounting to 1 display line.

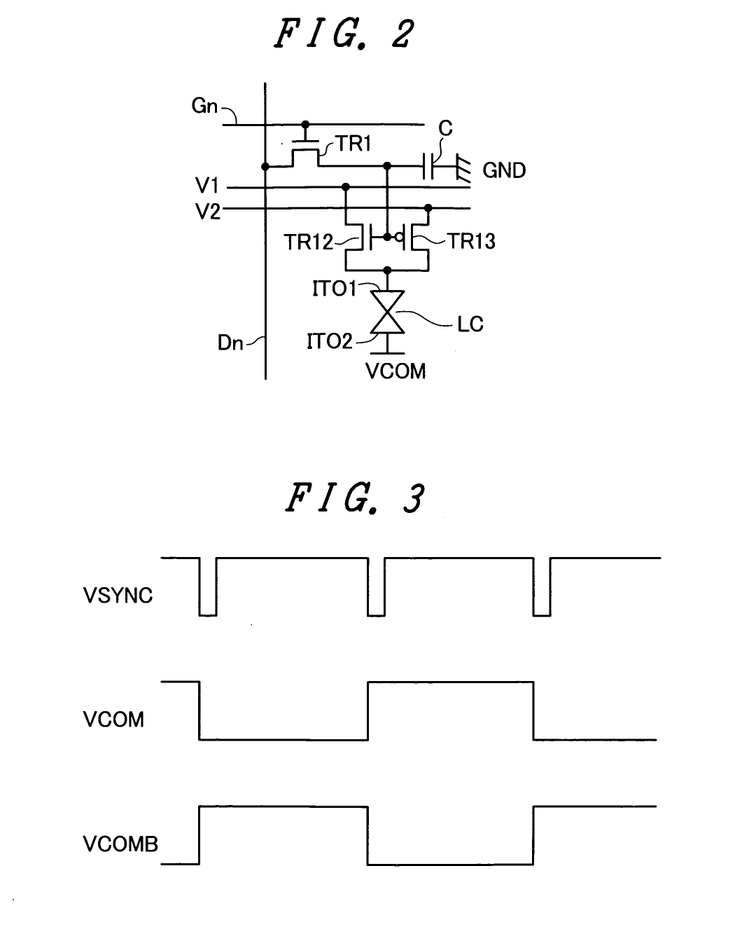

FIG. 2 is a view showing an equivalent circuit of the display pixel 10 of this embodiment.

In the drawing, an n-type transistor (TR1) is a transistor which constitutes an active element. A source of the n-type transistor (TR1) is connected to the video line (D) and a gate of the n-type transistor (TR1) is connected to the scanning line (G). Further, a capacitive element (C) is connected between the drain of the n-type transistor (TR1) and a reference potential (GND).

Further, the drain of the n-type transistor (TR1) is connected to gates of an n-type transistor (TR12) and a p-type transistor (TR13).

A source (or a drain) of the n-type transistor (TR12) is connected to a first power source line (V1), while the drain (or the source) of the n-type transistor (TR12) is connected to pixel electrode (ITO1).

A source (or a drain) of the p-type transistor (TR13) is connected to a second power source line (V2), while the drain (or the source) of the p-type transistor (TR13) is connected to pixel electrode (ITO1).

Here, to the first power source line (V1), a voltage of VCOM which is applied to a common electrode (also referred to as a counter electrode) (IT02) is applied, while to the second power source line (V2), a voltage of VCOMB which is obtained by inverting the voltage of VCOM is applied.

Liquid crystal (LC) is driven by an electric field which is generated between the pixel electrode (ITO1) and the common electrode (ITO2) which is arranged to face the pixel electrode (ITO1) in an opposed manner and an image is displayed on the display part 100. Here, the common electrodes (ITO2) may be formed on a substrate equal to a substrate on which the pixel electrodes (ITO1) are formed or may be formed on a substrate different from a substrate on which the pixel electrodes (ITO1) are formed.

Display data (Data) is inputted to the data latch circuit 140, is stored in the data latch circuit 140 by an amount corresponding to 1 display line using the horizontal shift register circuit 110, and the stored display data (Data) is read out onto the respective video lines (D1, D2 . . . ).

The vertical shift register circuit 120 sequentially outputs a scanning-line selective signal to the respective scanning lines (G) for every 1H period (scanning period) and hence, the transistors (TR1) which have gates thereof connected to the respective scanning lines (G) are turned on.

When the n-type transistor (TR1) which has the gate thereof connected to the scanning line (G) selected by the vertical shift register 120 is turned on, the display data (Data) supplied from the video line (D) is applied to gates of the n-type transistor (TR12) and the p-type transistor (TR13) respectively and, at the same time, is held in the capacitive element (C).

Here, the display data (Data) is either “1” or “0” and, in the capacitive element (C), a voltage of High level (hereinafter referred to as H level) indicative of “1” or a voltage of Low level (hereinafter referred to as L level) indicative of “0” is held.

In FIG. 2, when the display data (Data) is “1”, the n-type transistor (TR12) is turned on and the p-type transistor (TR13) is turned off and hence, the voltage of VCOM is applied to both of the pixel electrode (ITO1) and the counter electrode (ITO2).

That is, when the display data (Data) is “1”, voltages which are applied to both ends of the liquid crystal (LC) become equal to each other and hence, there is no inter-liquid-crystal potential difference whereby a “white” display is performed in a normally-white-type liquid crystal display panel.

Further, when the display data (Data) is “0”, the n-type transistor (TR12) is turned off and the p-type transistor (TR13) is turned on and hence, the voltage of VCOMB is applied to the pixel electrode (ITO1), and the voltage of VCOM is applied to the counter electrode (ITO2).

That is, when the display data (Data) is “0”, a voltage of (|VCOM-VCOMB|) is applied to both ends of the liquid crystal (LC) and hence, a “black” display is performed in the normally-white-type liquid crystal display panel.

The H level or the L level of the display data (Data) is held in the capacitive element (C) and hence, an image is displayed on the display part 100 even within a period in which there is no image inputting.

Then, when it is unnecessary to rewrite the image, it is possible to stop operations of the horizontal shift register circuit 110 and the vertical shift register circuit 120 whereby power consumption can be reduced.

Also in this embodiment, a common inversion driving method is adopted as an AC driving method of the liquid crystal display panel, in this embodiment, as shown in FIG. 3, it is sufficient to change the voltage of VCOM and the voltage of VCOMB which is obtained by inverting the voltage of VCOM corresponding to a common inversion cycle.

The voltage of VCOM is inverted between the L level (for example, 0V) and the H level (for example, 5V) corresponding to the common inversion cycle. The voltage of VCOMB is generated by inverting the voltage of VCOM using an inverter.

When the voltage of VCOM is at the L level, the voltage of VCOMB is at the H level, while when the voltage of VCOM is at the H level, the voltage of VCOMB is at the L level. That is, the voltage level of the voltage of VCOM and the voltage level of the voltage of VCOMB are changed over alternately at a predetermined cycle.

In this manner, in the liquid crystal display device described in the previously-mentioned patent document 1, while the related art requires 8 pieces of transistors per 1 display pixel, in this embodiment, by deleting a memory portion of the liquid crystal display device described in the above-mentioned patent document 1, the display pixel may be constituted of three transistors and hence, the number of pixels of the liquid crystal display panel can be increased compared to the related art.

### Embodiment 2

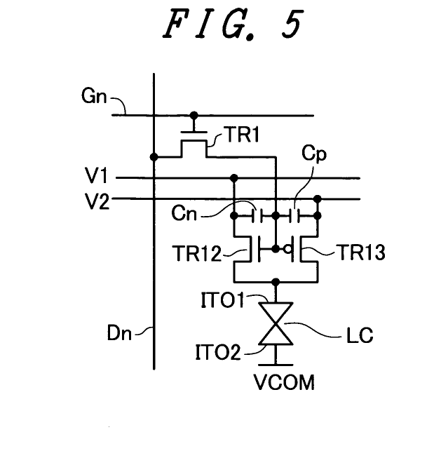

The display pixel 10 of the above-mentioned embodiment 1 requires the capacitive element (C) which holds the display data (Data). In this embodiment, as shown in FIG. 5, in place of the capacitive element (C), gate-source parasitic capacitances (Cn, Cp) of the n-type transistor (TR12) and the p-type transistor (TR13) are used.

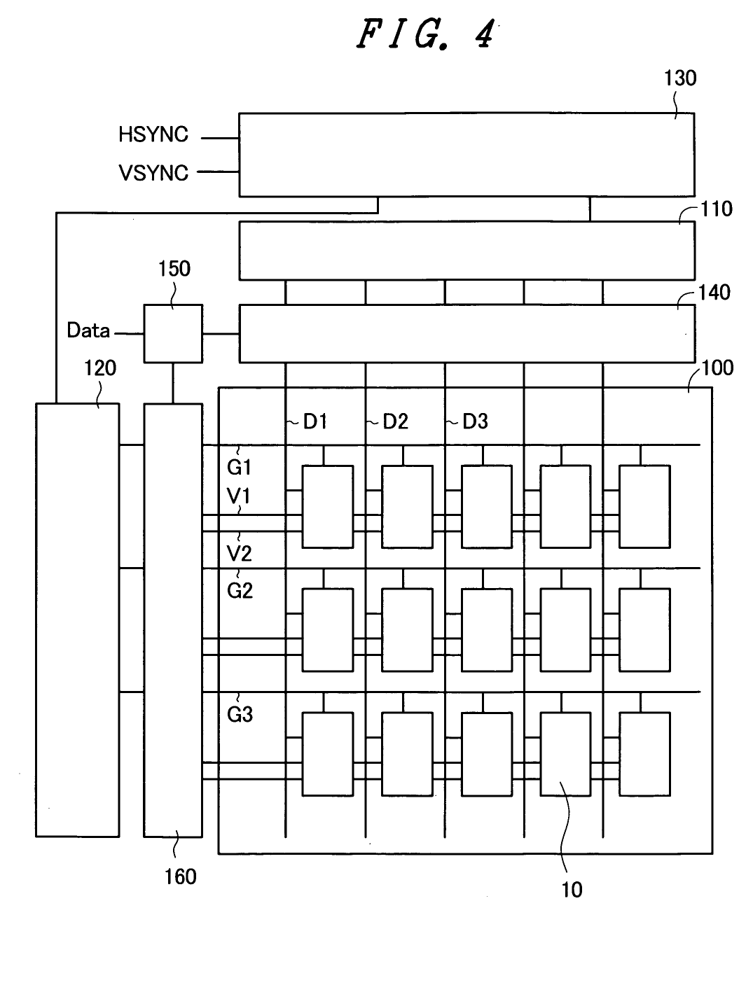

FIG. 4 is a block diagram showing the schematic constitution of a liquid crystal display device of the embodiment 2 of the present invention.

In this embodiment, as the display pixel 10 of the display part 100, the display pixel shown in FIG. 5 is used. The liquid crystal display device shown in FIG. 4 differs from the liquid crystal display device shown in FIG. 1 with respect to a point that a VCOM selector circuit 160 is inserted into a succeeding stage of the vertical shift register circuit 120 and a point that a data inversion circuit 150 which is synchronized a common inversion cycle is inserted into a preceding stage of the data latch circuit 140.

The voltage of VCOM is, as shown in FIG. 3, a voltage which is inverted for every frame, and the data inversion circuit 150 shown in FIG. 4 is a circuit which inverts data in synchronism with the inversion cycle of the voltage of VCOM.

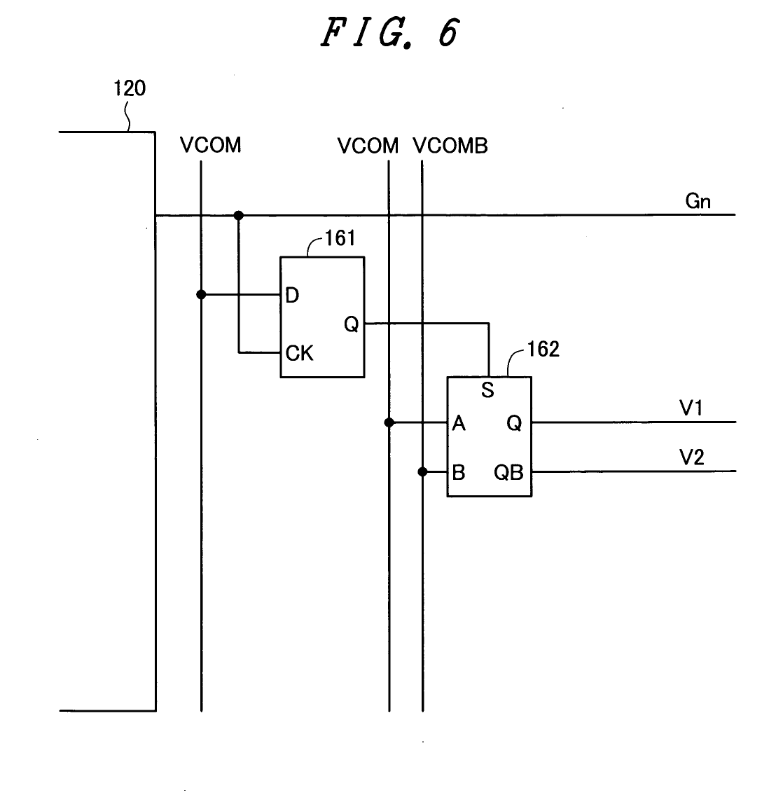

FIG. 6 is a view showing the circuit constitution of the VCOM selector circuit 160. As shown in FIG. 6, the VCOM selector circuit 160 is constituted of a flip-flop circuit (a D latch circuit) 161 and a selector circuit 162.

A true value table of the selector circuit 162 shown in FIG. 6 is shown in a following Table 1.

TABLE 1

| S | 0 | 1 |
|---|---|---|
| Q | A | B |
| QB | B | A |

Next, the manner of operation of the display device of this embodiment is explained.

In the frame in which the voltage of VCOM is at the L level, when 1 display line is selected, the D input of the flip-flop circuit 161 is at the L level, an output (Q) of the flip-flop circuit 161 is at the L level.

Accordingly, since the S input of the selector circuit 162 becomes “0” and hence, the voltage of VCOM is outputted to the first power source line (V1) and the voltage of VCOMB which is obtained by inverting the voltage of VCOM is outputted to the second power source line (V2).

As a result, in the frame in which the voltage of VCOM is at the L level, the voltage of VCOM at the L level is applied to the source of the n-type transistor (TR12) and the voltage of VCOMB at the H level is applied to the source of the p-type transistor (TR13).

Here, since the data inversion circuit 150 does not invert the inputted data, the display data (Data) with no change is inputted to the data latch circuit 140, the display data (Data) amounting to 1 display line is stored in the data latch circuit 140 and, thereafter, the display data (Data) is outputted to the video lines (D).

When the display data of “1” is applied to the gate of the n-type transistor (TR12) and the gate of the p-type transistor (TR13) from the video line (D) via the n-type transistor (TR1), the n-type transistor (TR12) is turned on and the p-type transistor (TR13) is turned off and hence, the voltage of VCOM is applied to the pixel electrode (ITO1).

That is, when the display data (Data) is 1, the voltages which are applied to both ends of the liquid crystal (LC) become equal and hence, there is no inter-liquid potential difference whereby a “white display” is performed in the case of the normally-white liquid crystal display panel.

Here, a potential difference of (Hdata-VCOM) is applied to both ends of the gate parasitic capacitance (Cn) of the n-type transistor (TR12) and hence, the potential difference of (Hdata-VCOM) is charged to both ends of the gate parasitic capacitance (Cn). Here, Hdata is a voltage level when the display data (Data) is “1”.

When the voltage of VCOM assumes the H level from the L level corresponding to the common inversion cycle in such a state, the gate-source potential difference is held as it is and the gate of the n-type transistor (TR12) assumes a voltage higher than the H level, the ON state of the n-type transistor (TR12) is maintained and the OFF state of the p-type transistor (TR13) is also maintained.

Further, when the display data of “0” is applied to the gate of the n-type transistor (TR12) and the gate of the p-type transistor (TR13) from the video line (D) via the n-type transistor (TR1), the n-type transistor (TR12) is turned off and the p-type transistor (TR13) is turned on and hence, the voltage of VCOMB is applied to the pixel electrode (ITO1).

That is, when the display data (Data) is “0”, the voltage of VCOMB is applied to the pixel electrode (ITO1) and the voltage of VCOM is applied to the counter electrode (ITO2) and hence, when the display data (Data) is “0”, a voltage of (|VCOM-VCOMB|) is applied to both ends of the liquid crystal (LC) and hence, a “black display” is performed in the case of the normally-white liquid crystal display panel.

Here, a potential difference of (VCOMB-Ldata) is applied to both ends of the gate parasitic capacitance (Cp) of the p-type transistor (TR13) and hence, the potential difference of (VCOMB-Ldata) is charged to both ends of the gate parasitic capacitance (Cp). Here, Ldata is a voltage level when the display data (Data) is “0”.

When the voltage of VCOMB assumes the L level from the H level corresponding to the common inversion cycle in such a state, the gate-source potential difference is held as it is and the gate of the p-type transistor (TR13) assumes a voltage lower than the L level and hence, the ON state of the p-type transistor (TR13) is maintained and the OFF state of the n-type transistor (TR12) is also maintained.

In the frame in which the voltage of VCOM assumes the H level, when an arbitrary 1 display line is selected, the D input of the flip-flop circuit 161 shown in FIG. 6 is at the H level, the output (Q) of the flip-flop circuit 161 assumes the H level.

Accordingly, the S input of the selector circuit 162 becomes “1” and hence, the voltage of VCOMB is outputted to the first power source line (V1) and the voltage of VCOM is applied to the second power source line (V2).

As a result, in the frame in which the voltage of VCOM is at the H level, the voltage of VCOMB at the L level is applied to the source of the n-type transistor (TR12), and the voltage of VCOM at the H level is applied to the source of the p-type transistor (TR13).

Here, the data inversion circuit 150 outputs the inputted data in an inverted manner and hence, the inverted display data (Data) is inputted to the data latch circuit 140, the display data (Data) amounting to 1 display line is stored in the data latch circuit 140 and, thereafter, the display data (Data) is outputted to the video line (D).

Accordingly, when the display data (Data) is “1”, the display data of “0” is applied to the gate of the n-type transistor (TR12) and the gate of the p-type transistor (TR13) from the video line (D) shown in FIG. 5 via the n-type transistor (TR1), the n-type transistor (TR12) is turned off and the p-type transistor (TR13) is turned on and hence, the voltage of VCOM is applied to the pixel electrode (ITO1).

That is, when the display data (Data) is 1, the voltages which are applied to both ends of the liquid crystal (LC) become equal and hence, there is no inter-liquid potential difference whereby a “white display” is performed in the case of the normally-white liquid crystal display panel.

Here, a potential difference of (VCOM-Ldata) is applied to both ends of the gate parasitic capacitance (Cp) of the p-type transistor (TR13) and hence, the potential difference of (VCOM-Ldata) is charged to both ends of the gate parasitic capacitance (Cp).

When the voltage of VCOM assumes the L level from the H level corresponding to the common inversion cycle in such a state, the gate-source potential difference is held as it is and the gate of the p-type transistor (TR13) assumes a voltage lower than the L level, the ON state of the p-type transistor (TR13) is maintained and the OFF state of the n-type transistor (TR12) is also maintained.

Further, when the display data (Data) is “0”, the display data of “1” is applied to the gate of the n-type transistor (TR12) and the gate of the p-type transistor (TR13) from the video line (D) shown in FIG. 5 via the n-type transistor (TR1), the n-type transistor (TR12) is turned on and the p-type transistor (TR13) is turned off and hence, the voltage of VCOMB is applied to the pixel electrode (ITO1).

That is, when the display data (Data) is “0”, the voltage of |VCOM-VCOMB| is applied to both ends of the liquid crystal (LC) and hence, the inter-liquid-crystal potential difference is generated whereby a “black display” is performed in the case of the normally-white liquid crystal display panel.

Here, a potential difference of (Hdata-VCOMB) is applied to both ends of the gate parasitic capacitance (Cn) of the n-type transistor (TR12) and hence, the potential difference of (Hdata-VCOMB) is charged to both ends of the gate parasitic capacitance (Cn).

When the voltage of VCOMB assumes the H level from the L level corresponding to the common inversion cycle in such a state, the gate-source potential difference is held as it is and the gate of the n-type transistor (TR12) assumes a voltage higher than the H level and hence, the ON state of the n-type transistor (TR12) is maintained and the OFF state of the p-type transistor (TR13) is also maintained.

### Embodiment 3

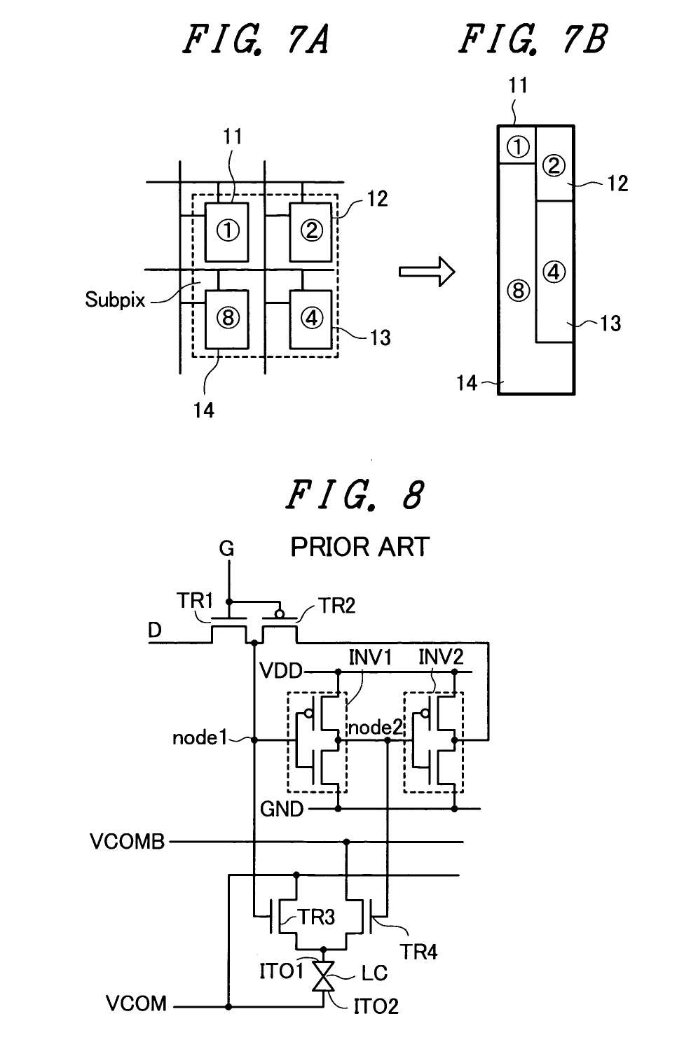

FIG. 7A and FIG. 7B show the constitution of a display pixel of a liquid crystal display device of the embodiment 3 according to the present invention.

This embodiment is an embodiment which adopts the area gradation. As shown in FIG. 7A, in this embodiment, one sub pixel (Subpix) is constituted of four display pixels (11 to 14).

Here, as shown in FIG. 7B, in four display pixels (11 to 14) which constitute one sub pixel (Subpix), predetermined weighting is applied to areas of pixel electrodes (ITO1).

In an example shown in FIG. 7B, the display data is display data of four bits (D0, D1, D2, D3), wherein areas of pixel electrodes (ITO1) of four display pixels (11 to 14) are substantially set at ratio of 1(=2⁰):2(=2¹):4(=2²):8(=2³).

Here, data of D0 out of display data of four bits (D0, D1, D2, D3) is inputted to the display pixel 11. In the same manner, data of D1 out of display data of four bits is inputted to the display pixel 12, data of D2 out of display data of four bits is inputted to the display pixel 13, and data of D3 out of display data of four bits is inputted to the display pixel 14.

In this embodiment, an equivalent circuit of four display pixels (11 to 14) is equal to the equivalent circuit shown in FIG. 2 or FIG. 5 and hence, the repeated explanation of the equivalent circuit is omitted.

Here, in the above-mentioned explanation, the case in which the display data is 4 bits is explained. However, when the display data is m (m≧2) bits, the number of display pixels which constitute one sub pixel (Subpix) becomes m. In this case, the weighting of the areas of the pixel electrodes may be performed at a ratio of 2⁰:2¹: , . . . , :2^{(m-1)}.

Further, in the above-mentioned respective embodiments, although the explanation has been made with respect to the case in which a peripheral circuit (for example, a drive circuit having shift registers and the like) is incorporated in the display panel (being integrally formed on a substrate of the display panel), the present invention is not limited to such constitutions and functions of some parts of the peripheral circuit may be performed by a semiconductor chip.

Further, in the above-mentioned respective embodiments, the explanation is made with respect to the case in which the transistor is used as the active element, the thin film transistor is used as the transistor, and the MOS transistor is used as the thin film transistor. However, a MIS transistor which has a broader concept than the MOS transistor may be used.

Although the invention which is made by inventors of the present invention has been specifically explained heretofore in conjunction with the embodiments, the present invention is not limited to the above-mentioned embodiments and various modifications are conceivable without departing from the gist of the present invention.

What is claimed is:

1. A display device which includes a display panel having a plurality of display pixels, video lines which apply video data to the display pixels and scanning lines which apply a scanning voltage to the display pixels, wherein
the display pixel includes:
a capacitive element which holds a voltage corresponding to a value of the video data;
a pixel electrode;
a first transistor of a first conductive type which is connected between a first power source line and the pixel electrode and, at the same time, has a control electrode to which the voltage held in the capacitive element is applied; and
a second transistor of a second conductive type different from the first conductive type which is connected between a second power source line and the pixel electrode and, at the same time, has a control electrode to which the voltage held in the capacitive element is applied, wherein
a first voltage is supplied to the first power source line, and
a second voltage is supplied to the second power source line, the second voltage being a voltage which is obtained by inverting the first voltage.

2. A display device according to claim 1, wherein the display pixel includes an active element which is turned off when a non-selective scanning voltage is applied to the scanning line and is turned on when a selective scanning voltage is applied, and a voltage corresponding to the value of the video data is applied to the capacitive element from the video line via the active element.

3. A display device according to claim 1, wherein the video data assumes binary values of “1” and “0”, and when the video data assumes “1”, the first transistor is turned on and the second transistor is turned off, while when the video data assumes “0”, the first transistor is turned off and the second transistor is turned on.

4. A display device according to claim 1, wherein the display pixel includes a common electrode which faces the pixel electrode in an opposed manner, and the first voltage is applied to the common electrode.

5. A display device according to claim 1, wherein the first voltage has a voltage level thereof inverted from a High level to a Low level or from the Low level to the High level at a predetermined inversion cycle.

6. A display device according to claim 1, wherein M pieces of display pixels constitute one sub pixel, and areas of the pixel electrodes of the respective M pieces of display pixels which constitute one sub pixel differ from each other.

7. A display device according to claim 6, wherein the video data is video data of m(m≧2) bits, M is m, and weighting is applied to the areas of the pixel electrodes of the respective M pieces of display pixels which constitute 1 sub pixel substantially at a rate of 2⁰:2¹: , . . . , :2^{(m-1)}.

8. A display device which includes a display panel having a plurality of display pixels, video lines which apply video data to the display pixels and scanning lines which apply a scanning voltage to the display pixels,
the display pixel includes:
a pixel electrode;
a first transistor of a first conductive type which is connected between a first power source line and the pixel electrode and, at the same time, has a control electrode to which the voltage corresponding to the value of the video data is applied; and
a second transistor of a second conductive type different from the first conductive type which is connected between a second power source line and the pixel electrode and, at the same time, has a control electrode to which the voltage corresponding to the value of the video data is applied, and
either one of a first voltage and a second voltage is supplied to the first power source line, and
another one of the first voltage and the second voltage is supplied to the second power source line, the second voltage being a voltage which is obtained by inverting the first voltage.

9. A display device according to claim 8, wherein the display pixel includes an active element which is turned off when a non-selective scanning voltage is applied to the scanning line and is turned on when a selective scanning voltage is applied, and a voltage corresponding to the value of the video data is applied to the control electrodes of the first transistor and the second transistor from the video line via the active element.

10. A display device according to claim 8, wherein the video data assumes binary values of “1” and “0”, and when the video data assumes “1”, the first transistor is turned on and the second transistor is turned off, while when the video data assumes “0”, the first transistor is turned off and the second transistor is turned on.

11. A display device according to claim 8, wherein the first transistor, when the first transistor assumes an ON state and, thereafter, the voltage corresponding to the value of the video data is not applied to the control electrode, maintains the ON state due to a voltage held in a first parasitic capacitance between the first electrode and the control electrode of the first transistor, and
the second transistor, when the second transistor assumes an ON state and, thereafter, the voltage corresponding to the value of the video data is not applied to the control electrode, maintains the ON state due to a voltage held in a second parasitic capacitance between the first electrode and the control electrode of the second transistor.

12. A display device according to claim 8, wherein the display pixel includes a common electrode which faces the pixel electrode in an opposed manner and the first voltage is applied to the common electrode.

13. A display device according to claim 8, wherein the first voltage has a voltage level thereof inverted from a High level to a Low level or from the Low level to the High level at a predetermined inversion cycle.

14. A display device according to claim 8, wherein when a voltage level of the first voltage assumes a Low level, the first voltage is supplied to the first power source line and the second voltage is supplied to the second power source line, while when a voltage level of the first voltage assumes a High level, the second voltage is supplied to the first power source line and the first voltage is supplied to the second power source line.

15. A display device according to claim 14, wherein the display device includes a selection circuit which selects the first voltage or the second voltage as the voltage supplied to the first power source line and the second power source line in response to the voltage level of the first voltage.

16. A display device according to claim 8, wherein the display device includes a data inversion circuit which inverts the video data in response to the voltage level of the first voltage.

17. A display device according to claim 16, wherein the data inversion circuit does not invert the video data when the voltage level of the first voltage assumes the Low level and inverts the video data when the voltage level of the first voltage assumes the High level.

18. A display device according to claim 8, wherein M pieces of display pixels constitute 1 sub pixel, and M pieces of display pixels which constitute 1 sub pixel make areas of the respective pixel electrodes thereof different from each other.

19. A display device according to claim 18, wherein the video data is video data of m(m≧2) bits, M is m, and weighting is applied to the areas of the pixel electrodes of the respective M pieces of display pixels which constitute 1 sub pixel substantially at a rate of 2⁰:2¹: , . . . , :2^{(m-1)}.

20. A display device according to claim 8, wherein the display device is a liquid crystal display device.
